(19) United States
(12) Patent Application Publication
(10) Pub. No.: US 2025/0370299 A1
(43) Pub. Date: Dec. 4, 2025

(54) LIQUID CRYSTAL DISPLAY PANEL AND DISPLAY DEVICE

(71) Applicant: Guangzhou China Star Optoelectronics Semiconductor Display Technology Co., LTd., Guangzhou, Guangdong (CN)

(72) Inventors: Zikang PAN, Guangzhou, Guangdong (CN); Mingjiue YU, Guangzhou, Guangdong (CN)

(73) Assignee: Guangzhou China Star Optoelectronics Semiconductor Display Technology Co., LTd., Guangzhou, Guangdong (CN)

(21) Appl. No.: 18/873,729

(22) PCT Filed: Oct. 31, 2023
(86) PCT No.: PCT/CN2023/128487

§ 371 Date: Dec. 10, 2024

(30) Foreign Application Priority Data
Apr. 26, 2023 (CN) 202310467186.0

(51) Int. Cl. G02F 1/1337; G02F 1/1343

(52) U.S. Cl. CPC G02F 1/133707; G02F 1/134309

(57) ABSTRACT

The present disclosure provides a liquid crystal display panel and a display device. The liquid crystal display panel at least includes a plurality of sub-pixels, liquid crystal molecules, and an alignment film. The plurality of sub-pixels have a plurality of domain areas and one or more junction areas each of which is between two corresponding adjacent domain areas. There is a symmetry axis between every two adjacent domain areas. Liquid crystal molecules are distributed in the plurality of domain areas and the junction area(s). The alignment film is provided in the plurality of domain areas and the junction area(s).

### TECHNICAL FIELD

The present application relates to the field of display technology, and in particular, to a liquid crystal display panel and a display device.

### BACKGROUND

Currently, TFT-LCD displays exhibit noticeable color casts when viewed from different angles, with vertical alignment (VA) mode being particularly affected. To address this issue, a commonly employed approach is a multi-domain design for pixel electrodes. This design allows the liquid crystal molecules to deflect in various directions within different domain areas, ensuring consistent screen brightness across different viewing angles and mitigating the color casts.

However, existing multi-domain designs feature junction areas between adjacent domain areas, where an electric field distribution is relatively disordered. Consequently, the liquid crystal molecules in these junction areas cannot achieve optimal deflection as in the domain areas, resulting in reduced light transmittance.

### SUMMARY

This application provides a liquid crystal display panel and a display device, aiming to ameliorate the disordered arrangement of liquid crystal molecules in the junction area between adjacent domain areas to improve the light transmittance.

In an aspect, some embodiments of the present disclosure provide a liquid crystal display panel, including:

a plurality of sub-pixels, having a plurality of domain areas and one or more junction areas, each junction area being between two corresponding adjacent domain areas of the plurality of domain areas, wherein there is a symmetry axis between every two adjacent ones of the domain areas;

liquid crystal molecules distributed in the plurality of domain areas and the one or more junction areas; and

an alignment film provided in the plurality of domain areas and the one or more junction areas, wherein the alignment film has one or more alignment structures in each junction area;

wherein each alignment structure in each junction area is arranged symmetrically about the symmetry axis of the two adjacent domain areas corresponding to the junction area.

In some embodiments, in a junction area of the one or more junction areas, a top view of the one or more alignment structures viewed from a thickness direction of the alignment film are one or more triangles or rectangles.

In some embodiments, a shape of each alignment structure in the junction area is a triangular prism or a triangular pyramid.

In some embodiments, the top view of the one alignment structure in the junction area viewed from the thickness direction of the alignment film is one triangle or one rectangle, and the triangle or the rectangle extends along an extending direction of the junction area.

In some embodiments, the top view of the alignment structures in the junction area viewed from the thickness direction of the alignment film is a plurality of triangles or a plurality of rectangles, and the plurality of triangles or the plurality of rectangles are arranged at one or more intervals along an extending direction of the junction area.

In some embodiments, the alignment structures in the junction area are arranged at one or more intervals along the extending direction of the junction area, or the one alignment structure extends continuously along the junction area.

In some embodiments, the liquid crystal display panel further includes:

an electrode layer, comprising a plurality of sub-electrodes located in the domain areas, wherein each domain area includes two or more of the plurality of sub-electrodes,

wherein the two or more sub-electrodes in each domain area are arranged parallel to each other, two or more of the plurality of the sub-electrodes in different ones of the plurality of domain areas are respectively arranged along different directions, and the sub-electrodes respectively in two adjacent ones of the domain areas are arranged symmetrically about the symmetry axis of the two adjacent domain areas.

In some embodiments, the junction area corresponding to the two adjacent domain areas comprises a first junction area and a second junction area that are symmetrical about the symmetry axis, and the junction area has a shape of a triangle or a rectangle.

In some embodiments, the one or more alignment structures in the junction area have a first alignment direction in the first junction area and a second alignment direction in the second junction area. An arrangement direction of the sub-electrodes in one of the two adjacent domain areas which is adjacent to the first junction area is parallel to the first alignment direction, and an arrangement direction of the sub-electrodes in the other of the two adjacent domain areas which is adjacent to the second junction area is parallel to the second alignment direction.

In some embodiments, the electrode layer includes at least one of a pixel electrode and a common electrode.

In some embodiments, the liquid crystal display panel further includes:

a first substrate and a second substrate arranged oppositely,

wherein the liquid crystal molecules are located between the first substrate and the second substrate, and the alignment film is located on a side of the first substrate facing the second substrate and/or is located on a side of the second substrate facing the first substrate; and the electrode layer is located on the side of the first substrate facing the second substrate and/or is located on the side of the second substrate facing the first substrate.

In another aspect, some embodiments of the present disclosure further provide a display device including the liquid crystal display panel according to any one of the above embodiments.

### BENEFICIAL EFFECTS

Some embodiments of the present disclosure provide a liquid crystal display panel and a display device, which at least includes a plurality of sub-pixels, liquid crystal molecules, and an alignment film. The plurality of sub-pixels include a plurality of domain areas and one or more junction areas each of which is between two corresponding adjacent domain areas. The liquid crystal molecules are distributed in the plurality of domain areas and the junction area(s). The alignment film is disposed in the plurality of domain areas and the junction area(s). The alignment film has an alignment structure (alignment structures) in each junction area. The alignment structure is symmetrically arranged about the symmetry axis. The alignment structure(s) fixes the orientation of the liquid crystal molecules in the junction area. Therefore, the liquid crystal molecules in the junction area between adjacent domain areas have a fixed orientation arrangement, improving light transmittance.

### BRIEF DESCRIPTION OF THE DRAWINGS

The technical solutions and other beneficial effects of the present disclosure will be apparent through a detailed description of specific embodiments of the present disclosure in conjunction with the accompanying drawings.

FIG. 1 is a schematic top structural view of a liquid crystal display panel according to some embodiments of the present disclosure.

FIG. 2 is a schematic cross-sectional view of a liquid crystal display panel according to some embodiments of the present disclosure.

FIG. 3 is a schematic structural diagram of an arrangement of liquid crystal molecules according to some embodiments of the present disclosure.

FIG. 4 is a schematic structural diagram of an alignment structure according to some embodiments of the present disclosure.

FIG. 5 is a schematic structural diagram of another alignment structure according to some embodiments of the present disclosure.

FIG. 6 is a schematic top structural view of a liquid crystal display panel according to some embodiments of the present disclosure.

FIG. 7 is a schematic top structural view of another liquid crystal display panel according to some embodiments of the present disclosure.

FIG. 8 is a schematic top structural view of still another liquid crystal display panel according to some embodiments of the present disclosure.

FIG. 9 is a schematic top structural view of yet another liquid crystal display panel according to some embodiments of the present disclosure.

### EMBODIMENTS OF THE INVENTION

The technical solutions in the embodiments of the present disclosure will be clearly and completely described below with reference to the accompanying drawings in the embodiments of the present disclosure. Apparently, the described embodiments are only some of the embodiments of the present disclosure, rather than all of the embodiments. Based on the embodiments in the present disclosure, all other embodiments obtained by those skilled in the art without creative efforts fall within the scope of protection of the present disclosure.

In the description of the present disclosure, it should be understood that the terms “first” and “second” are only used for descriptive purposes and cannot be understood as indicating or implying relative importance or implicitly indicating the number of indicated technical features. Thus, features defined as “first” and “second” may explicitly or implicitly include one or more of the described features. In the description of the present disclosure, “plurality” means two or more than two, unless otherwise explicitly and specifically limited.

In the present disclosure, unless otherwise expressly stated and limited, a first feature being “above” or “below” a second feature may include the first feature directly contacting the second feature or the first feature contacting the second feature via an addition feature therebetween. Furthermore, the first feature being “above”, “over”, “on” the second feature may include the first feature being directly above and diagonally above the second feature, or simply mean that the first feature is higher in level than the second feature. The first feature being “under”, “below”, “beneath” the second feature may include the first feature being directly below and diagonally below the second feature, or simply means that the first feature is less in level than the second feature.

The following disclosure provides many different embodiments or examples for implementing various structures of the present disclosure. To simplify the disclosure of the present application, the components and arrangements of specific examples are described below. Of course, they are merely examples and are not intended to limit the present disclosure. Furthermore, the present disclosure may repeat reference numbers and/or reference letters in different examples, and such repetition is for the purposes of simplicity and clarity and does not by itself indicate a relationship between the various embodiments and/or arrangements discussed. In addition, the present disclosure provides examples of various specific processes and materials, but one of ordinary skill in the art will recognize the applications of other processes and/or the use of other materials.

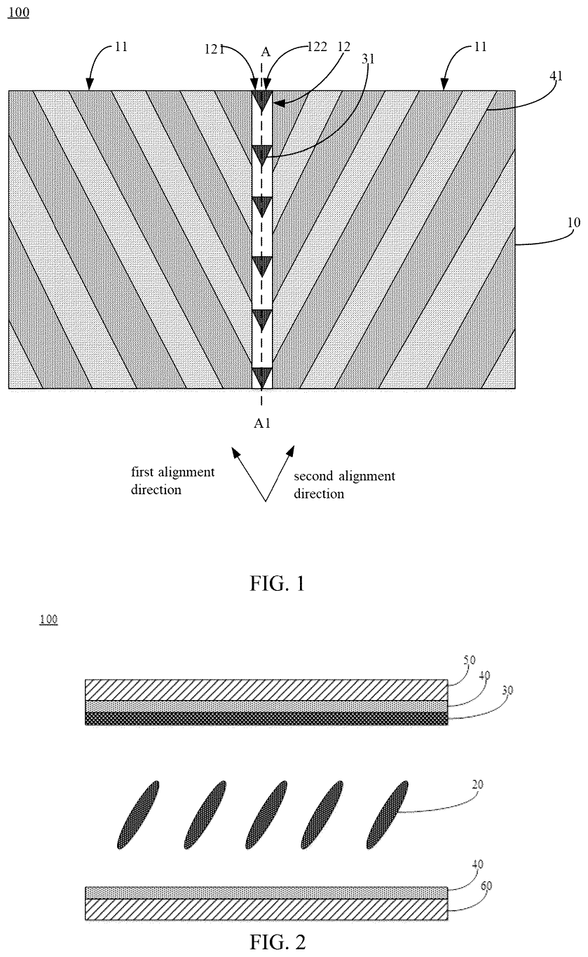

Please refer to FIG. 1, which is a schematic top structural view of a liquid crystal display panel according to some embodiments of the present disclosure. Please also refer to FIG. 2, which is a schematic cross-sectional view of a liquid crystal display panel according to some embodiments of the present disclosure. The liquid crystal display panel 100 may be applied to various electronic devices. The liquid crystal display panel 100 at least includes a plurality of sub-pixels 10, liquid crystal molecules 20, and an alignment film 30.

The plurality of sub-pixels 10 have a plurality of domain areas 11 and one or more junction areas 12 each of which is between two corresponding adjacent domain areas 11. There is a symmetry axis A-A1 between every two adjacent domain areas 11. The liquid crystal molecules 20 are distributed in the plurality of domain areas 11 and the one or more junction areas. The alignment film 30 is provided in the plurality of domain areas 11 and the junction area(s) 12. The alignment film 30 has an alignment structure (alignment structures) 31 in each junction area 12. The alignment structure 31 is symmetrically arranged about the symmetry axis A-A1. The alignment structure 31 may fix the orientation of the liquid crystal molecules 20 in the junction area 12. Therefore, the fixed-orientation arrangement of the liquid crystal molecules 20 in each junction area 12 between the adjacent domains 11 may improve the light transmittance.

In some embodiments, the liquid crystal display panel 100 further includes an electrode layer 40, and the electrode layer 40 includes a plurality of sub-electrodes 41 located in the domain areas 11, wherein each domain area 11 contains two or more of the plurality of sub-electrodes 41. Among the plurality of sub-electrodes, two or more sub-electrodes 41 in one domain area 11 are arranged parallel to each other, and two or more sub-electrodes 41 in different domain areas 11 are respectively arranged along different directions. Specifically, sub-electrodes 41 in two adjacent domain areas 11 are arranged symmetrically about the symmetry axis A-A1. Since the sub-electrodes 41 in different domain areas 11 are arranged in different directions, the liquid crystal molecules 20 may be deflected in different directions in different domain areas 11, thereby ensuring consistent screen brightness across different viewing angles and mitigating the color casts.

The electrode layer 40 may include at least one of a pixel electrode and a common electrode, that is, the electrode layer 40 may include the pixel electrode, the common electrode, or both the pixel electrode and the common electrode.

In some embodiments, the liquid crystal display panel 100 may further include a first substrate 50 and a second substrate 60 arranged oppositely. The liquid crystal molecules 20 are located between the first substrate 50 and the second substrate 60, the alignment film 30 is located on a side of the first substrate 50 facing the second substrate 60, and/or is located on a side of the second substrate 60 facing the first substrate 50. The electrode layer 40 is located on a side of the first substrate 50 facing the second substrate 60, and/or is located on a side of the second substrate 60 facing the first substrate 50.

The first substrate 50 and the second substrate 60 each may be one of an array substrate and a color filter substrate. That is, when the first substrate 50 is the array substrate, the second substrate 60 is the color filter substrate, or when the first substrate 50 is the color filter substrate, the second substrate 60 is the array substrate. Therefore, the alignment film 30 may be positioned to either the side of the array substrate facing the color filter substrate, or to the side of the color filter substrate facing the array substrate. Alternatively, the alignment film 30 may be positioned to both the side of the first substrate 50 facing the second substrate 60 and simultaneously the side of the second substrate 60 facing the first substrate 50. The electrode layer 40 may be positioned to either the side of the array substrate facing the color filter substrate, or to the side of the color filter substrate facing the array substrate. Alternatively, the electrode layer 40 may be positioned to both the side of the first substrate 50 facing the second substrate 60 and simultaneously the side of the second substrate 60 facing the first substrate 50.

When the electrode layer 40 and the alignment film 30 are arranged on a side of the first substrate 50 (i.e., the first substrate 50 side), the electrode layer 40 is positioned between the first substrate 50 and the alignment film 30. When the electrode layer 40 and the alignment film 30 are arranged on a side of the second substrate 60 (i.e., the second substrate 60 side), the electrode layer 40 is layer 40 is positioned between the second substrate 60 and the alignment film 30.

In an embodiment, as shown in FIG. 2, the first substrate 50 is positioned above the second substrate 60, and the liquid crystal display panel 100 includes the first substrate 50, the electrode layer 40, the alignment film 30, the liquid crystal molecules 20, the electrode layer 40, and second substrate 60 from top to bottom.

When the electrode layer 40 is positioned either on the first substrate 50 side or the second substrate 60 side, the electrode layer 40 may be a pixel electrode or a common electrode. When there are electrode layers 40 on both the first substrate 50 side and the second substrate 60 side, one of the electrode layers 40 may be a pixel electrode, and the other one of the electrode layers 40 may be a common electrode.

As shown in FIG. 1, this embodiment only shows two adjacent domain areas 11. It can be understood that the liquid crystal display panel 100 may include more domain areas 11, such as 4, 8, and 16 domain areas. In the absence of an electric field, the alignment film 30 itself has an initial alignment direction, so that the liquid crystal molecules 20 are fixedly oriented. However, when an electric field is applied, the liquid crystal molecules 20 in each domain area 11 may have a fixed orientation according to a direction in which the sub-electrodes 41 are arranged. However, there are no sub-electrode 41 in each junction area 12. Therefore, an electric field distribution in the junction area 12 is disordered, and hence the arrangement of the liquid crystal molecules 20 in the junction area 12 is disordered, resulting in low light transmittance of the junction area 12. In this embodiment, an alignment structure(s) 31 is (are) added to the alignment film 30 of the junction area 12. The alignment structure 31 may fix the orientation of the liquid crystal molecules 20 in the junction area 12, thus improving the light transmittance of the junction area 12.

In some embodiments, the junction area 12 includes a first junction area 121 and a second junction area 122 that are symmetrical about the symmetry axis A-A1. A shape of the junction area 12 may be a long rectangle, which is symmetrical about the symmetry axis A-A1. The alignment film 30 may have a plurality of alignment structures 31 in the junction area 12. The alignment structure 31 is in shape of a triangle in a top view when viewed from a thickness direction of the alignment film 30, and the triangle is symmetrical about the symmetry axis A-A1.

In some embodiments, the alignment structures 31 each have a first alignment direction in the first junction area 121 and a second alignment direction in the second junction area 122. Therefore, the liquid crystal molecules 20 in the first junction area 121 may be aligned along the first alignment direction, and the liquid crystal molecules 20 in the second junction area 122 may be aligned along the second alignment direction.

An arrangement direction of the sub-electrodes 41 adjacent to the first junction area 121 is parallel to the first alignment direction. An arrangement direction of the sub-electrodes 41 adjacent to the second junction area 122 is parallel to the second alignment direction. In this way, the sub-electrodes 41 may have an arrangement direction consistent with the alignment direction of each alignment structure 31 on the same side of the symmetry axis A-A1 as the sub-electrodes 41. The plurality of alignment structures 31 are arranged at intervals along the extending direction of the junction area 12.

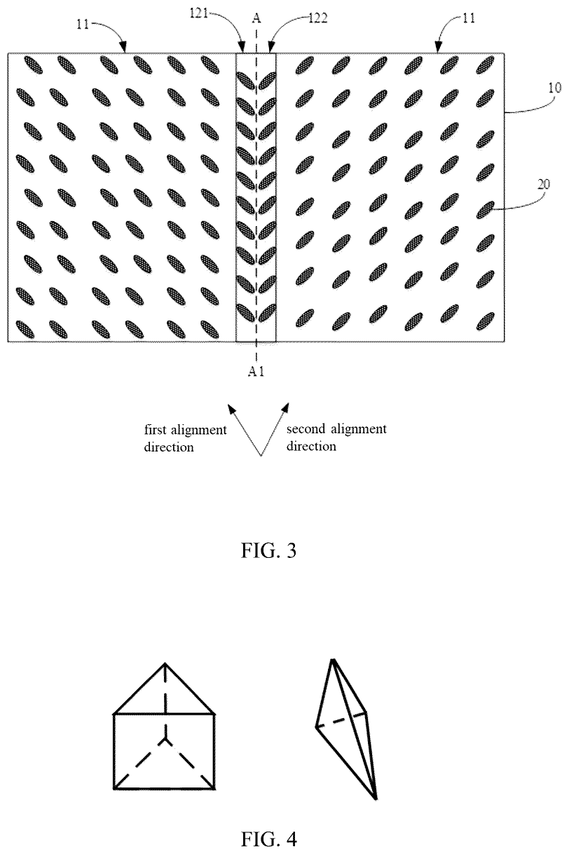

Please refer to FIG. 3. FIG. 3 is a schematic structural diagram of an arrangement of liquid crystal molecules according to some embodiments of the present disclosure. The alignment structures 31 make the arrangement direction of the liquid crystal molecules 20 in the first junction area 121 consistent with the arrangement direction of the liquid crystal molecules 20 in a domain area 11 adjacent to this first junction area 121. For example, the liquid crystal molecules 20 on the left side of the symmetry axis A-Al are aligned along the first alignment direction, and the liquid crystal molecules 20 on the right side of the symmetry axis A-Al are aligned along the second alignment direction.

Please refer to FIGS. 4 and 5. FIG. 4 is a schematic structural diagram of an alignment structure according to some embodiments of the present disclosure, and FIG. 5 is a schematic structural diagram of another alignment structure according to some embodiments of the present disclosure.

As shown in FIG. 4, the alignment structure 31 has a triangular top view when viewed from the thickness direction of the alignment film 30. For example, the alignment structure 31 may be a triangular prism symmetrical about the symmetry axis A-A1, or may be a triangular pyramid symmetrical about the symmetry axis A-A1. As shown in FIG. 5, the alignment structure 31 has a long rectangular top view.

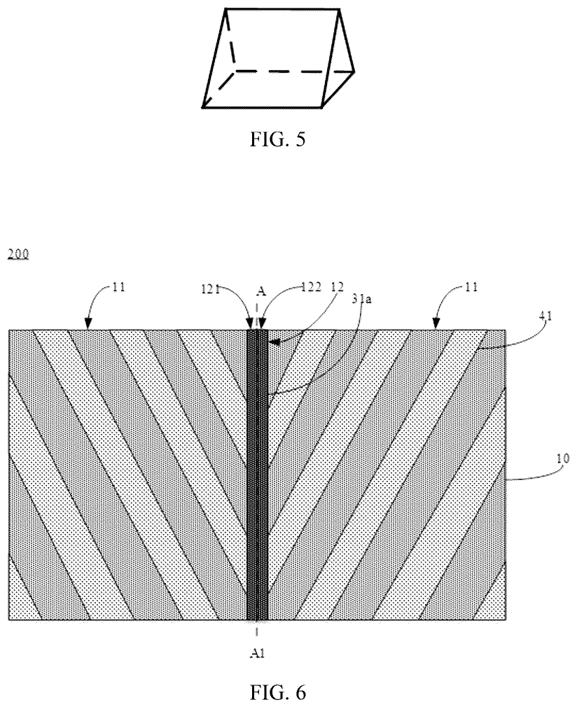

Please refer to FIG. 6, which is a schematic top structural view of a liquid crystal display panel according to some embodiments of the present disclosure. For ease of understanding and brief description, same structures in the embodiments of the present disclosure continue to use the same reference signs as in the above embodiments, and the same structures will not be described in detail.

A difference between the display panel 200 herein and the above-mentioned display panel 100 is that the alignment film 30 may have a single alignment structure 31a in the junction area 12. The alignment structure 31a may have a rectangular top view, and the alignment structure 31a continuously extends along an extending direction of the junction area 12. An orthographic projection of the alignment structure 31a on the junction area 12 coincides with the junction area 12.

Please refer to FIG. 7, which is a schematic top structural view of another liquid crystal display panel according to some embodiments of the present disclosure. For ease of understanding and brief description, same structures in the embodiments of the present disclosure continue to use the same reference signs as in the above embodiments, and the same structures will not be described in detail.

A difference between the display panel 300 herein and the above-mentioned display panel(s) is that the alignment film 30 may include a plurality of alignment structures 31b in the junction area 12. The alignment structures 31b may each have a rectangular top view, and the plurality of alignment structures 31b are arranged at intervals along the extending direction of the junction area 12.

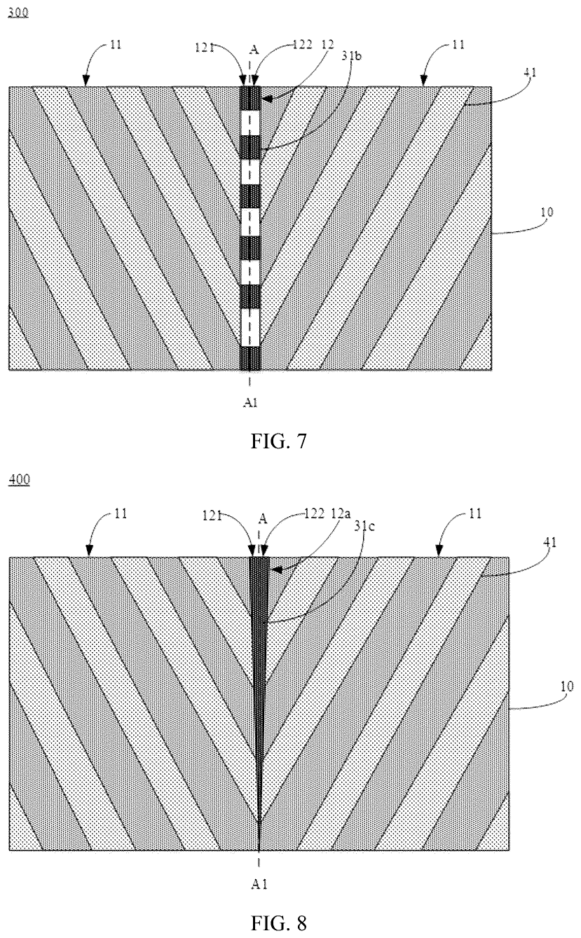

Please refer to FIG. 8, which is a schematic top structural view of still another liquid crystal display panel according to some embodiments of the present disclosure. For ease of understanding and brief description, same structures in the embodiments of the present disclosure continue to use the same reference numerals as in the above embodiments, and the same structures will not be described in detail.

A difference between this display panel 400 and the above-mentioned display panel(s) is that a shape of the junction area 12a may be a long triangle. The alignment film 30 has a single alignment structure 31c in the junction area 12a. The alignment structure 31c may have a triangular top view, and the alignment structure 31c extends continuously along the junction area 12a.

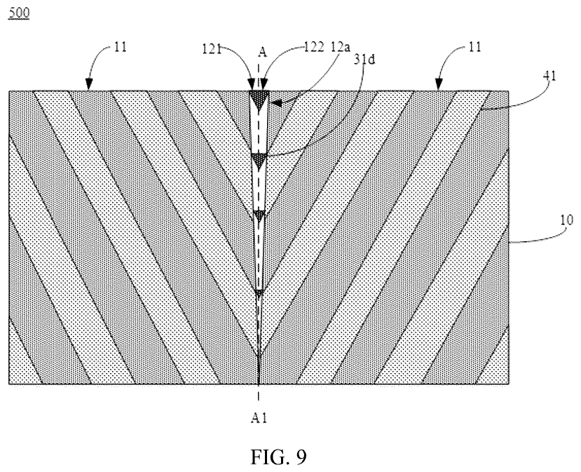

Please refer to FIG. 9, which is a schematic top structural view of yet another liquid crystal display panel according to some embodiments of the present disclosure. For ease of understanding and brief description, same structures in the embodiments of the present disclosure continue to use the same reference numerals as in the above embodiments, and the same structures will not be described in detail.

A difference between this display panel 500 and the above-mentioned display panel(s) is that a shape of the junction area 12a may be a long triangle, and the alignment film 30 may have a plurality of alignment structures 31d in the junction area 12a. The alignment structure 31d may each have a triangular top view, and the plurality of the alignment structures 31d may be arranged at intervals along the extending direction of the junction area 12a.

Some embodiments of the present disclosure provide a liquid crystal display panel, which at least includes a plurality of sub-pixels 10, liquid crystal molecules 20, and an alignment film 30. The plurality of sub-pixels 10 include a plurality of domain areas 11 and one or more junction areas each of which is between two corresponding adjacent domain areas. The liquid crystal molecules 20 are distributed in the plurality of domain areas 11 and junction areas. The alignment film 30 is disposed in the plurality of domain areas 11 and the junction areas. The alignment film 30 has an alignment structure (alignment structures) in each junction area. The alignment structure is symmetrically arranged about the symmetry axis A-A1. The alignment structure(s) fixes the orientation of the liquid crystal molecules 20 in the junction area. Therefore, the liquid crystal molecules 20 in the junction area between adjacent domain areas 11 have a fixed orientation arrangement, improving light transmittance.

On the other hand, some embodiments of the present disclosure further provide a display device, which at least includes the liquid crystal display panel provided in any of the above embodiments.

The description of the above embodiments is only used to help understand the technical solutions and core ideas of the present disclosure. Those of ordinary skill in the art should understand that they may still modify the technical solutions recorded in the foregoing embodiments, or make equivalent substitutions for some of the technical features therein. These modifications or substitutions do not cause the essence of the corresponding technical solutions to depart from the scope of the technical solutions of the embodiments of the present disclosure.

1. A liquid crystal display panel, comprising:
a plurality of sub-pixels, having a plurality of domain areas and one or more junction areas, each junction area being between two corresponding adjacent domain areas of the plurality of domain areas, wherein there is a symmetry axis between every two adjacent ones of the domain areas;
liquid crystal molecules distributed in the plurality of domain areas and the one or more junction areas; and
an alignment film provided in the plurality of domain areas and the one or more junction areas, wherein the alignment film has one or more alignment structures in each junction area;
wherein each alignment structure in each junction area is arranged symmetrically about the symmetry axis of the two adjacent domain areas corresponding to the junction area.

2. The liquid crystal display panel according to claim 1, wherein in a junction area of the one or more junction areas, a top view of the one or more alignment structures viewed from a thickness direction of the alignment film are one or more triangles or rectangles.

3. The liquid crystal display panel according to claim 2, wherein a shape of each alignment structure in the junction area is a triangular prism or a triangular pyramid.

4. The liquid crystal display panel according to claim 2, wherein the top view of the one alignment structure in the junction area viewed from the thickness direction of the alignment film is one triangle or one rectangle, and the triangle or the rectangle extends along an extending direction of the junction area.

5. The liquid crystal display panel according to claim 2, wherein the top view of the alignment structures in the junction area viewed from the thickness direction of the alignment film is a plurality of triangles or a plurality of rectangles, and the plurality of triangles or the plurality of rectangles are arranged at one or more intervals along an extending direction of the junction area.

6. The liquid crystal display panel according to claim 2, wherein the alignment structures in the junction area are arranged at one or more intervals along the extending direction of the junction area, or the one alignment structure extends continuously along the junction area.

7. The liquid crystal display panel according to claim 1, further comprising:
an electrode layer, comprising a plurality of sub-electrodes located in the domain areas, wherein each domain area includes two or more of the plurality of sub-electrodes,
wherein the two or more sub-electrodes in each domain area are arranged parallel to each other, two or more of the plurality of the sub-electrodes in different ones of the plurality of domain areas are respectively arranged along different directions, and the sub-electrodes respectively in two adjacent ones of the domain areas are arranged symmetrically about the symmetry axis of the two adjacent domain areas.

8. The liquid crystal display panel according to claim 7, wherein the junction area corresponding to the two adjacent domain areas comprises a first junction area and a second junction area that are symmetrical about the symmetry axis, and the junction area has a shape of a triangle or a rectangle.

9. The liquid crystal display panel according to claim 8, wherein the one or more alignment structures in the junction area have a first alignment direction in the first junction area and a second alignment direction in the second junction area, and
an arrangement direction of the sub-electrodes in one of the two adjacent domain areas which is adjacent to the first junction area is parallel to the first alignment direction, and an arrangement direction of the sub-electrodes in the other of the two adjacent domain areas which is adjacent to the second junction area is parallel to the second alignment direction.

10. The liquid crystal display panel according to claim 7, wherein the electrode layer comprises at least one of a pixel electrode and a common electrode.

11. The liquid crystal display panel according to claim 7, further comprising a first substrate and a second substrate arranged oppositely,
wherein the liquid crystal molecules are located between the first substrate and the second substrate, and the alignment film is located on a side of the first substrate facing the second substrate and/or is located on a side of the second substrate facing the first substrate, and
the electrode layer is located on the side of the first substrate facing the second substrate and/or is located on the side of the second substrate facing the first substrate.

12. A display device, wherein the display device comprises a liquid crystal display panel, and the liquid crystal display panel comprises:
a plurality of sub-pixels, having a plurality of domain areas and one or more junction areas, each junction area being between two corresponding adjacent domain areas of the plurality of domain areas, wherein there is a symmetry axis between every two ones of the adjacent domain areas;
liquid crystal molecules distributed in the plurality of domain areas and the one or more junction areas; and
an alignment film provided in the plurality of domain areas and the one or more junction areas, wherein the alignment film has one or more alignment structures in each junction area;
wherein each alignment structure in each junction area is arranged symmetrically about the symmetry axis of the two adjacent domain areas corresponding to the junction area.

13. The display device according to claim 12, wherein in a junction area of the one or more junction areas, a top view of the one or more alignment structures viewed from a thickness direction of the alignment film are one or more triangles or rectangles.

14. The display device according to claim 13, wherein a shape of each alignment structure in the junction area is a triangular prism or a triangular pyramid.

15. The display device according to claim 13, wherein the alignment structures in the junction area are arranged at one or more intervals along the extending direction of the junction area, or the one alignment structure extends continuously along the junction area.

16. The display device according to claim 12, wherein the liquid crystal display panel further comprises:
an electrode layer, comprising a plurality of sub-electrodes located in the domain areas, wherein each domain area includes two or more of the plurality of sub-electrodes,
wherein the two or more sub-electrodes in each domain area are arranged parallel to each other, two or more of the plurality of the sub-electrodes in different ones of the plurality of domain areas are respectively arranged along different directions, and the sub-electrodes respectively in two adjacent ones of the domain areas are arranged symmetrically about the symmetry axis of the two adjacent domain areas.

17. The display device according to claim 16, wherein the junction area corresponding to the two adjacent domain areas comprises a first junction area and a second junction area that are symmetrical about the symmetry axis, and the junction area has a shape of a triangle or a rectangle.

18. The display device according to claim 17, wherein the one or more alignment structures in the junction area have a first alignment direction in the first junction area and a second alignment direction in the second junction area, and
an arrangement direction of the sub-electrodes in one of the two adjacent domain areas which is adjacent to the first junction area is parallel to the first alignment direction, and an arrangement direction of the sub-electrodes in the other of the two adjacent domain areas which is adjacent to the second junction area is parallel to the second alignment direction.

19. The display device according to claim 16, wherein the electrode layer comprises at least one of a pixel electrode and a common electrode.

20. The display device according to claim 16, wherein the liquid crystal display panel further comprises a first substrate and a second substrate arranged oppositely,
wherein the liquid crystal molecules are located between the first substrate and the second substrate, and the alignment film is located on a side of the first substrate facing the second substrate and/or is located on a side of the second substrate facing the first substrate, and
the electrode layer is located on the side of the first substrate facing the second substrate and/or is located on the side of the second substrate facing the first substrate.
